(19) United States
(12) Patent Application Publication
(10) Pub. No.: US 2017/0283626 A1
(43) Pub. Date: Oct. 5, 2017

(54) Coating Composition with Rheology Modifier

(71) Applicant: Valspar Sourcing, Inc., Minneapolis, MN (US)

(72) Inventors: Karl A. Booth, Mundelein, IL (US); Kenneth F. Czaplewski, Westmont, IL (US); Stephen M. Korenkiewicz, Lake Zurich, IL (US); Jeffrey F. Taylor, Cincinnati, OH (US)

(73) Assignee: Valspar Sourcing, Inc., Minneapolis, MN (US)

(21) Appl. No.: 15/623,816

(22) Filed: Jun. 15, 2017

Related U.S. Application Data
(63) Continuation of application No. PCT/US2015/066618, filed on Dec. 18, 2015.
(60) Provisional application No. 62/266,105, filed on Dec. 11, 2015.
(60) Provisional application No. 62/094,186, filed on Dec. 19, 2014.

(51) Int. Cl. C09D 7/00; C09D 175/08; C08G 18/28; C09D 7/06

(52) U.S. Cl. CPC C09D 7/002; C09D 7/06; C09D 175/08; C08G 18/283; C08G 18/2835

(57) ABSTRACT

A coating composition including a rheology modifier is described. The rheology modifier is a water-soluble polyurethane made by the condensation of a poly(alkylene glycol), a polyisocyanate and a compound including a polyalkoxylated chain and a hydrophobic end group. The composition demonstrates Leneta sag resistance of greater than about 14 and a Leneta flow and leveling of at least about 9, and a Stormer viscosity of less than about 120 Krebs units.

### CROSS REFERENCE TO RELATED APPLICATION(S)

This application is a continuation of International Application No. PCT/US2015/066618 filed on 18 Dec. 2015, which claims the benefit of U.S. Provisional Application No. 62/094,186 filed on Dec. 19, 2014 and U.S. Provisional Application No. 62/266,105 filed on Dec. 11, 2015, each of which is incorporated herein by reference in its entirety.

### BACKGROUND OF THE INVENTION

Coating compositions, including architectural paints, for example, are provided in a wide variety of finishes, and the ultimate finish of a paint depends on a number of factors, including the rheology profile of the coating composition.

The rheology of a coating composition is a function of its visco-elastic properties, including sag resistance and flow and leveling. These properties exist in an inverse relationship, where a composition with excellent flow and leveling will have poor sag resistance, whereas a composition with excellent sag resistance will show poor flow and leveling. As a result, the composition may be difficult to apply and/or will not result in a coated article with a smooth finish.

Conventionally, this problem is addressed by the use of thickeners or rheology modifiers in the coating compositions. However, many thickeners must be used in formulations made at high pH, have poor viscosity, show low water resistance, or reduce compatibility with various pigments commonly used in formulations.

Therefore, there is a need for a rheology modifier to be used in a coating composition with excellent sag resistance and flow and leveling, and a viscosity profile that allows for easy application and a smooth finish.

### BRIEF DESCRIPTION OF THE FIGURES

FIG. 1 is a graphic representation of the dynamic visco-elastic behavior of a coating composition when applied to a substrate.

### SUMMARY

The present disclosure provides a coating composition including at least a rheology modifier. In an aspect, the rheology modifier described herein provides an improved rheology profile or rheology behavior relative to conventional coating compositions that do not include the disclosed rheology modifier. Specifically, the composition with the rheology modifier has a Leneta sag resistance of greater than about 14 and a Leneta flow and leveling of greater than about 9. In addition, the composition with the rheology modifier has Stormer viscosity of less than about 120 Krebs units (KU).

In one embodiment, the rheology modifier is a water-soluble polyurethane made by the condensation of at least one poly(alkylene glycol), at least one polyisocyanate, and at least one compound having the formula (I) or (II):

R—(OE)ₘ—OH (I)

In the compound of formula I, R is preferably one or more aromatic moieties having between 2 and 5 phenyl rings, OE preferably represents a polyethoxylated chain, and m is preferably a whole number or fraction representing the number of OE units present in the compound of formula (I),i.e. 6 to 12.

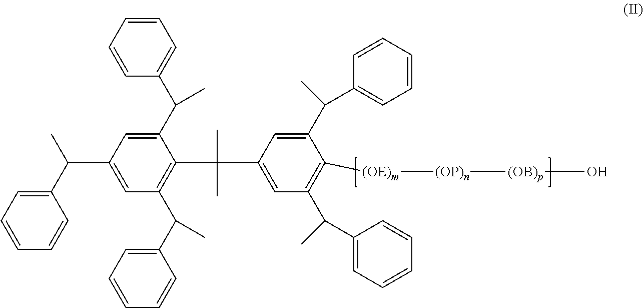

In the compound of formula (II), the [(EO)ₘ—(PO)ₙ—(BO)ₚ] preferably represents a polyalkoxylated chain including alkoxylated units chosen from among ethoxylated units EO, propoxylated units PO, and butoxylated units BO, where m, n and p are preferably each independently either zero, or a whole number between 2 and 250, and where the sum of m, n and p is between 2 and 250.

The composition with the rheology modifier has a Leneta sag resistance of greater than about 14 and a Leneta flow and leveling of at least 9 or greater than about 9. In addition, the composition with the rheology modifier has Stormer viscosity of less than about 120 Krebs units (KU).

In another embodiment, the present description provides a method of improving the rheology profile of a coating composition. The method includes steps for providing an aqueous coating composition; and adding the water-soluble polyurethane rheology modifier described herein to the composition to provide a coating composition having a Leneta sag resistance of at least about 14 and a Leneta flow and leveling of at least 9 or greater than about 9.

In yet another embodiment, the present description provides a method for preventing the reduction of viscosity of a paint formulation on the addition of a tint or colorant. The method includes steps of providing a base paint formulation, adding a colorant formulation to tint the base paint formulation to a desired color, and adjusting the viscosity of the tinted base paint by addition of the water-soluble polyurethane rheology modifier described herein.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise specified, the following terms as used herein have the meanings as provided below.

The term “component” refers to any compound that includes a particular feature or structure. Examples of components include compounds, monomers, oligomers, polymers, and organic groups contained there.

The term “base paint” refers to a coating composition that is complete insofar as it is capable of receiving additional adjuvants or pigment for tinting or other end use related purposes. In certain instances, a base paint formulation may be tinted at a point-of-sale by the addition of an amount of colorant, pigment or dye.

The term “rheology modifier,” as used herein, refers to an additive that influences viscosity at high and/or low shear rates and may also contribute to consistency of a coating composition. For convenience, the terms “rheology modifier” and “thickener” are used interchangeably herein.

The term “water-soluble” in the context of a polymer as used herein means that the polymer can be mixed into water (or an aqueous carrier) to form a stable mixture. For example, a mixture that readily separates into immiscible layers is not a stable mixture. The term “water-dispersible” is intended to include the term “water-soluble.” In other words, by definition, a water-soluble polymer is also considered to be a water-dispersible polymer.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one embodiment, the present description provides a coating composition including at least a rheology modifier. In an aspect, the rheology modifier described herein provides an improved rheology profile or rheology behavior relative to conventional coating compositions that do not include the disclosed rheology modifier. Specifically, the composition with the rheology modifier has a Leneta sag resistance of greater than about 14 and a Leneta flow and leveling of at least 9 or greater than about 9, preferably a Leneta sag resistance of at least about 16 and a Leneta flow and leveling of at least about 10, and more preferably, a Leneta sag resistance of greater than about 16 and a Leneta flow and leveling of greater than about 10. In addition, the composition with the rheology modifier has Stormer viscosity of less than about 120 Krebs units (KU), preferably about 90 to 120 KU.

In an embodiment, the present description provides a coating composition including at least a rheology modifier. In an aspect, the rheology modifier is a water-soluble polyurethane. The water-soluble polyurethane is made by the condensation of at least one poly(alkylene glycol), at least one polyisocyanate, and at least one compound having the formula (I) or (II):

R—(OE)ₘ—OH (I)

In the compound of forumula (I) R is preferably one or more aromatic moieties having between 2 and 5 phenyl rings, OE preferably represents a polyethoxylated chain, and m is preferably a whole number or fraction representing the number of OE units present in the compound of formula (I).

In an embodiment, the R group of the compound of formula (I) is a hydrophobic end group including preferably 2 to 5 phenyl rings. In an aspect, the R group has about preferably 25 to 40 carbon atoms, more preferably 30 to 35 carbon atoms. In another aspect, the R group is preferably a hydrophobe having a size of preferably about 200 to 600, more preferably 300 to 500.

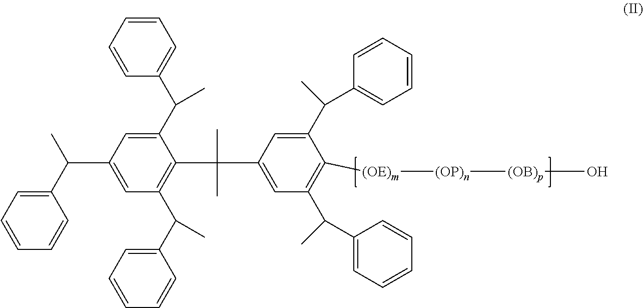

In the compound of formula (II), the [(EO)ₘ—(PO)ₙ—(BO)ₚ] moiety preferably represents a polyalkoxylated chain including alkoxylated units chosen from among ethoxylated units EO, propoxylated units PO, and butoxylated units BO, where m, n and p are each independently either zero, or a whole number between 2 and 250, and where the sum of m, n and p is between 2 and 250. The composition with the rheology modifier has a Leneta sag resistance of greater than about 14, preferably at least 16, and a Leneta flow and leveling of at least about 9, preferably greater than about 9. In addition, the composition with the rheology modifier has Stormer viscosity of less than about 120 Krebs units (KU).

As disclosed herein, the [(EO)ₘ—(PO)ₙ—(BO)ₚ] moiety of the compound of formula (II) is a polyalkoxyated chain having EO groups m units in length, PO groups n units in length, and BO groups p units in length. In an aspect, m, n, and p are each independently zero or an integer or whole number between 1 and 250, preferably 2 and 20, more preferably 3 and 15. In an aspect, the sum of m, n, and p is between 2 and 250, preferably 2 and 20, more preferably 3 and 15.

In a preferred embodiment, the R group of formula (I) is a tristyrylphenyl (TSP) group having the formula (III):

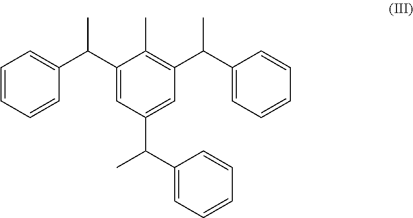 [SMILES: Cc1c(C(C)c2ccccc2)cc(C(C)c2ccccc2)cc1C(C)c1ccccc1]

In an embodiment, the present description provides a coating composition including at least a rheology modifier. In an aspect, the rheology modifier is a water-soluble polyurethane. The water-soluble polyurethane is made by the condensation of at least one poly(alkylene glycol), at least one polyisocyanate, and at least one compound having the formula (I) above. Suitable poly(alkylene glycols) include, without limitation, poly(ethylene glycol), commonly known as PEG, poly(propylene glycol), and the like. In a preferred aspect, the poly(alkylene glycol) is poly(ethylene glycol). In an aspect, the PEG has weight average molecular weight (Mw) of 2,000 to 20,000.

In an embodiment, the present description provides a coating composition including at least a rheology modifier. In an aspect, the rheology modifier is a water-soluble polyurethane. The water-soluble polyurethane is made by the condensation of at least one poly(alkylene glycol), at least one polyisocyanate, and at least one compound having the formula (I) above. Suitable polyisocyanates include, for example, polymers derived from isocyanate-functional components including, for example, aliphatic isocyanates, cycloaliphatic isocyanates, aromatic isocyanates, and combinations thereof. The isocyanate-functional may include one or more isocyanate moieties, and preferably includes two or more isocyanate moieties (e.g., diisocyanates). Examples of specific suitable compounds for the isocyanate-functional compound include tetramethylene diisocyanates, hexamethylene diisocyanates, cyclohexamethylene methylene cyclohexyl isocyanates, isophorone diisocyanates, diisocyanates, toluene diisocyanates, methylene diphenyl diisocyanates, methylene diphenyl diisocyanates, phenylene diisocyanates, and combinations thereof.

Suitable polyisocyanates may also include polyisocyanates derived from compounds that contain isocyanurate, biuret, allophanate, iminooxadiazinedione, urethane, urea, or uretdione groups. Polyisocyanates containing urethane groups, for example, are obtained by reacting some of the isocyanate groups with polyols, such as trimethylolpropane, neopentyl glycol, and glycerol, for example.

In an embodiment, the coating composition described herein includes at least a rheology modifier. In an aspect, the rheology modifier is a water-soluble polyurethane resulting from the condensation of about 0.5 to 50 weight percent of at least one compound having the formula (I), about 50 to 99.5 weight percent of at least one poly(alkylene glycol), and about 0.5 to 50 weight percent of at least one polyisocyanate. In a preferred aspect, the water-soluble polyurethane results from the condensation of about 1 to 29 weight percent of at least one compound having the formula (I), about 70 to 98 weight percent of at least one poly(alkylene glycol) and about 1 to 29 weight percent of at least one polyisocyanate, based on the total weight of the composition, i.e. where the sum of the above weight percentages is equal to 100.

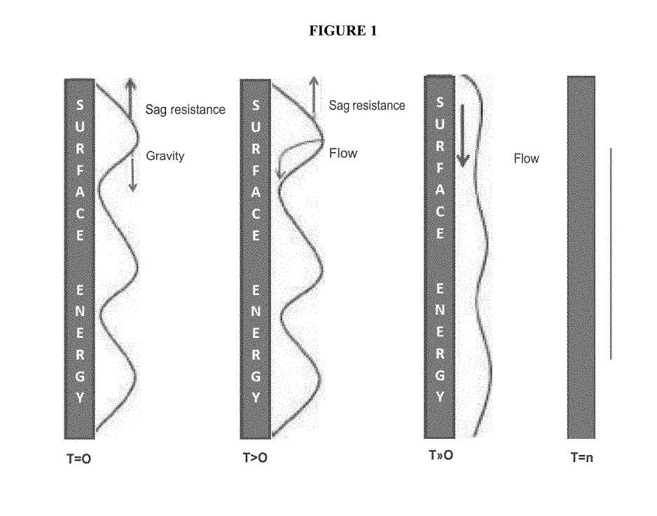

Coating compositions, including for example, paints, lacquers, stains, varnishes, and the like, come in a variety of finishes, corresponding to different levels of specular gloss. Common finishes include flat, matte, eggshell, satin, silk, semi-gloss, high-gloss, and the like. It is known in the art that the finish is dependent on the rheological properties or visco-elastic properties of the coating composition, including sag resistance, the ability of the composition to flow and level, and the viscosity of the composition. As illustrated in FIG. 1, when a paint is first applied to a surface by conventional means, the paint must have good initial sag resistance to avoid paint curtaining, i.e. the paint must be able to resist the force of gravity to prevent the paint flowing downwards and clumping at the bottom of the wall like a curtain. The initial resistance to gravity must transition into an ability to flow into a smooth finish and then level out as the coating dries out into the final finish.

Conventional paint formulations include rheology modifiers to control visco-elastic properties. These formulations demonstrate a strong correlation between sag resistance and flow and leveling. Formulations that show excellent sag resistance behavior will have poor flow and leveling, and inversely, formulations that have excellent flow will show poor sag resistance properties. These relationships translate into a lack of smoothness when the paint formulation is applied to a substrate surface such as a wall.

Surprisingly, and in contrast to conventional expectations of skilled artisans in the field, the water-soluble polyurethane-based rheology modifier described herein shows both excellent sag resistance and excellent flow and leveling behavior. As a result, the coating compositions that include the described rheology modifier show exceptionally smooth finish on application.

Without limiting to theory, it is believed that the improvement in sag resistance and flow and leveling behavior is a result of the combination of the hydrophobic end group described above and the length of the polyethoxylated chain linking the hydrophone to the polyurethane backbone, i.e. the spacer length. Spacer lengths of less than about 6 result in undesirably high viscosity and poorer flow performance relative to a longer spacer length of 10 for example. However, longer spacer lengths result in poor sag resistance.

Accordingly, in an embodiment, the present description provides a method to improve the sag and leveling of an aqueous coating composition. The method includes steps of providing an aqueous coating composition; and adding the water-soluble polyurethane rheology modifier described herein to the composition to provide a coating composition having a Leneta sag resistance of at least about 14 and a Leneta flow and leveling of at least 9, preferably Leneta sag resistance of at least about 16, and a Leneta flow and leveling of at least about 10, and more preferably, Leneta sag resistance of greater than about 16, and a Leneta flow and leveling of greater than about 10.

In an embodiment, the rheology modifier described herein is used in an aqueous or water-based coating composition. Examples of such coating compositions include, without limitation, paints, lacquers, varnishes, stains, waterproofing coatings, putties, base coats, primer coats, thick coatings, thin films, and the like. A suitable example of the coating composition described herein is a latex-based paint system, such as a TiO₂-containing water-based latex paint system. Another suitable example of a coating composition described herein is a latex-based clear base paint formulation to be tinted to a desired color by the addition of a suitable colorant, preferably at a point-of-sale. Useful colorants for tinting base paints include colorants for use with solvent-based paints, colorants for use with water-based paints, and universal colorants which may be used with solvent-based and water-based paints alike.

Coating compositions as described herein may be made by conventional methods known to those of skill in the art. For example, a water-based coating composition can be made by making a pigment grind dispersion that includes one or more latex polymers combined with a slurry of a pigment such as TiO₂, for example. The rheology modifier described herein is added to the pigment grind dispersion, which is then made into a formulation of the coating composition by the addition of adjuvants and other additives conventional in the art. Such additives include one or more of a surfactant, a defoaming agent, additives used to regulate pH, coalescents or coalescing agents, extender pigments, biocides, mildewcides, and the like.

In an embodiment, the present description provides water-based latex base paints. A paint formulation of a desired color may be made by adding a colorant composition to the water-based latex base paint, such as for example, when a paint is tinted to a desired color at a point of sale. Typically, the viscosity of the base paint decreases when the colorant composition is added, and therefore, the colored paint formulation will have a lower viscosity and may have poor properties on application to a substrate. Accordingly, in an aspect, the rheology modifier described herein may be used in a method to improve the viscosity of a colored or tinted paint and/or prevent the reduction in viscosity that occurs when a tint or colorant is added to a water-based latex base paint. The method includes steps of providing a base paint formulation, adding a colorant formulation to tint the base paint formulation to a desired color, and adjusting the viscosity of the tinted base paint by addition of the water-soluble polyurethane rheology modifier described herein.

The coating compositions described herein may be used in a wide variety of applications, including for example, as a paint for architectural surfaces (i.e. walls, ceilings, doors, trim, etc.), drywall, masonry, wood, metal, plastics, and primed surfaces. In a preferred aspect, the coating composition described herein is a water-based latex paint for interior and/or exterior architectural surfaces.

The coating compositions described herein may be applied to one or more surfaces by conventional methods known to those of skill in the art. Suitable examples include, without limitation, application by aerosol spray, brush, roller, airless spray, air-assisted spray, high volume low pressure (HVLP) spray, and the like.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight.

### Test Methods

Unless indicated otherwise, the following test methods were utilized in the Examples that follow.

### A. Leneta Sag Resistance

The sag resistance of the coating compositions described herein is evaluated according to the method described in ASTM D4400 (Standard Test Method for Sag Resistance of Paints Using a Multinotch Applicator), at room temperature. The results of this test for coatings prepared according to the present invention are presented in Table 2.

### B. Leneta Flow and Leveling

The flow and leveling of the coating compositions described herein is evaluated according to the method described in ASTM D4062 (Standard Test Method for Leveling of Paints by Draw-Down Method), at room temperature. The results of this test for coatings prepared according to the present invention are presented in Table 2.

### C. Viscosity Testing

The viscosity of the coating compositions described herein is evaluated according to the method described in ASTM D562-10 (Standard Test Method for Consistency of Paints Measuring Krebs Unit (KU) Viscosity using a Stormer-type Viscometer). The results of this test for coatings prepared according to the present invention are presented in Tables 3 and 4.

### Example 1

### Preparation of Samples

Pigment grind dispersions were prepared by combining and mixing the ingredients listed below in Table 1. In Table 1, Comparative Example A refers to a composition made with one or more conventional, commercially available urethane-based thickeners or rheology modifiers, such as, for example, ACRYSOL™ RM825 (Dow Chemical Company). Inventive Examples 1-5 represent compositions made with the rheology modifiers of the invention that include compounds of formula (I), with spacer lengths of 3, 8, 10, 15 and 25 respectively. All the inventive examples include the same hydrophobic moiety, have the same particle size and particle morphology.

TABLE 1
Preparation of Pigment Grind Dispersions

| | Exam- | Exam- | Exam- | Exam- | Exam- |
|---|---|---|---|---|---|
| Ingredient | ple A | ple 1 | ple 2 | ple 3 | ple 4 |
| INITIAL | | | | | |
| MIXTURE (PRE- | | | | | |
| LETDOWN): | | | | | |
| Water | 67 | 67 | 67 | 67 | 67 |
| Second polymer | 274 | 274 | 274 | 274 | 274 |
| First polymer | 154 | 154 | 154 | 154 | 154 |
| Defoamer | 1 | 1 | 1 | 1 | 1 |
| TiO₂ slurry (75 wt. | 343 | 343 | 343 | 343 | 343 |
| % KRONOS ™ 4310) | | | | | |
| Stir for 10-20 minutes | | | | | |
| GRIND: | | | | | |
| Water | 28 | 28 | 28 | 28 | 28 |
| Amine buffer | 1 | 1 | 1 | 1 | 1 |
| Solvent | 4.5 | 4.5 | 4.5 | 4.5 | 4.5 |
| Defoamer | 1 | 1 | 1 | 1 | 1 |
| Dispersant | 1.2 | 1.2 | 1.2 | 1.2 | 1.2 |
| Extender Pigment | 20 | 20 | 20 | 20 | 20 |
| Preservative | 1.6 | 1.6 | 1.6 | 1.6 | 1.6 |
| Mix in High Speed | | | | | |
| Disperser 20 minutes | | | | | |
| LETDOWN | | | | | |
| (ADDED TO THE | | | | | |
| GRIND): | | | | | |
| Coalescent | 6.5 | 6.5 | 6.5 | 6.5 | 6.5 |
| Surfactant | 2 | 2 | 2 | 2 | 2 |
| Mildewcide | 2.5 | 2.5 | 2.5 | 2.5 | 2.5 |
| Mix 2 minutes | | | | | |
| Add to Pre-Letdown | | | | | |
| Water (to rinse | 18.5 | 18.5 | 18.5 | 18.5 | 18.5 |
| grind kettle) | | | | | |
| Open time additive | 10 | 10 | 10 | 10 | 10 |
| HEUR “high shear” | 40 | 40 | 40 | 40 | 40 |
| thickener | | | | | |
| Acrysol RM825 | 3.4 | | | | |
| Second low shear | 0.5 | | | | |
| HEUR thickener | | | | | |
| Low shear thickener | | 5.0 | 4.0 | 4.0 | 5.0 |
| Opaque polymer | 30 | 30 | 30 | 30 | 30 |
| (ROPAQUE ™ | | | | | |
| ULTRA) | | | | | |
| Wetting agent | 1 | 1 | 1 | 1 | 1 |
| Defoamer | 1.5 | 1.5 | 1.5 | 1.5 | 1.5 |
| Water | 54 | 54 | 54 | 54 | 54 |
| TOTAL PARTS | 1066 | 1067 | 1066 | 1066 | 1067 |

### Example 2

### Preparation of Samples

Pigment grind dispersions were prepared by combining and mixing the ingredients listed below in Table 2. In Table 2, Comparative Examples A and B refer to compositions made with one or more conventional, commercially available urethane-based thickeners or rheology modifiers, such as, for example, ACRYSOL™ RM825 (Dow Chemical Company). Inventive Examples 1-5 represent compositions made with the rheology modifiers of the invention that include compounds of formula (II), with spacer lengths of 3, 8, 10, 15 and 40 respectively. All the inventive examples include the same hydrophobic moiety, have the same particle size and particle morphology.

TABLE 2
Preparation of Pigment Grind Dispersions

| | Comparative | Comparative | Inventive | Inventive | Inventive | Inventive | Inventive |
|---|---|---|---|---|---|---|---|
| Ingredient | Example A | Example B | Example 1 | Example 2 | Example 3 | Example 4 | Example 5 |
| INITIAL | | | | | | | |
| MIXTURE | | | | | | | |
| Water | 67 | 67 | 67 | 67 | 67 | 67 | 67 |
| Second polymer | 274 | 274 | 269 | 269 | 269 | 269 | 269 |
| First polymer | 154 | 154 | 154 | 154 | 154 | 152 | 154 |
| Defoamer | 1 | 1 | 1 | 1 | 1 | 1 | 1 |
| TiO2 slurry (75 wt. % | 343 | 343 | 343 | 343 | 343 | 343 | 343 |
| Stir for 10-20 minutes | | | | | | | |
| GRIND: | | | | | | | |
| Water | 28 | 28 | 28 | 28 | 28 | 28 | 28 |
| Amine buffer | 1 | 1 | 1 | 1 | 1 | 1 | 1 |
| Solvent | 4.5 | 4.5 | 4.5 | 4.5 | 4.5 | 4.5 | 4.5 |
| Defoamer | 1 | 1 | 1 | 1 | 1 | 1 | 1 |
| Dispersant | 1.2 | 1.2 | 1.2 | 1.2 | 1.2 | 1.2 | 1.2 |
| Extender Pigment | 20 | 20 | 20 | 20 | 20 | 20 | 20 |
| Preservative | 1.6 | 1.6 | 1.6 | 1.6 | 1.6 | 1.6 | 1.6 |
| Mix in High Speed | | | | | | | |
| Disperser 20 minutes | | | | | | | |
| LETDOWN | | | | | | | |
| (ADDED TO THE | | | | | | | |
| GRIND): | | | | | | | |
| Coalescent | 6.5 | 6.5 | 6.5 | 6.5 | 6.5 | 6.5 | 6.5 |
| Surfactant | 2 | 2 | 2 | 2 | 2 | 2 | 2 |
| Mildewcide | 2.5 | 2.5 | 2.5 | 2.5 | 2.5 | 2.5 | 2.5 |
| Mix 2 minutes | | | | | | | |
| Add to Pre-Letdown | | | | | | | |
| Water (to rinse | 18.5 | 18.5 | 18.5 | 18.5 | 18.5 | 18.5 | 18.5 |
| grind kettle) | | | | | | | |
| Open time additive | 10 | 10 | 10 | 10 | 10 | 10 | 10 |
| HEUR “high shear” | 40 | 40 | 32 | 32 | 32 | 32 | 32 |
| thickener | | | | | | | |
| Acrysol RM825 | 3.4 | 3.5 | | | | | |
| Second low shear | 0.5 | 0.4 | | | | | |
| HEUR thickener | | | | | | | |
| Inventive low shear | | | | | | | |
| thickener | | | 4.5 | 4.0 | 4.0 | 4.0 | 6.3 |
| Opaque polymer | 30 | 30 | 30 | 30 | 30 | 30 | 30 |
| (ROPAQUE ™ | | | | | | | |
| ULTRA) | | | | | | | |
| Wetting agent | 1 | 1 | 1 | 1 | 1 | 1 | 1 |
| Defoamer | 1.5 | 1.5 | 1.5 | 1.5 | 1.5 | 1.5 | 1.5 |
| Water | 54 | 54 | 65 | 66 | 66 | 68 | 63 |
| TOTAL PARTS | 1066 | 1066 | 1065 | 1065 | 1065 | 1065 | 1065 |

### Example 3

### Performance Testing

The pigment grind dispersions from Examples 1 and 2 were combined with additional ingredients, i.e. adjuvants and additives needed to make finished paint formulations. The resulting paint formulations were allowed to equilibrate for a minimum period of 18 hours. Following the equilibration period, films were cast and evaluated for Leneta sag resistance and Leneta flow and leveling as described above. The viscosity was also measured. The results collected are shown in Tables 3 and 4.

TABLE 3
Results of Performance Testing (Example 1)

| | Exam- | Exam- | Exam- | Exam- | Exam- |
|---|---|---|---|---|---|
| Evaluation | ple A | ple 1 | ple 2 | ple 3 | ple 4 |
| Low Shear Thickener | | 3 | 8 | 10 | 25 |
| Spacer Length | | | | | |
| Stormer KU Viscosity, | 113 | 124.3 | 109.4 | 108.8 | 107 |
| Krebs | | | | | |
| Leneta, Flow and | 9 | 6 | 10 | 9 | 10 |
| Leveling | | | | | |
| Leneta Anti-Sag | 8 | 20 | 22 | 16 | 10 |
| Resistance | | | | | |

TABLE 4
Results of Performance Testing (Example 2)

| | Comparative | Comparative | Inventive | Inventive | Inventive | Inventive | Inventive |
|---|---|---|---|---|---|---|---|
| Evaluation | Example A | Example B | Example 1 | Example 2 | Example 3 | Example 4 | Example 5 |
| Low Shear | | | 3 | 8 | 10 | 15 | 40 |
| Thickener | | | | | | | |
| Spacer | | | | | | | |
| Length | | | | | | | |
| Stormer KU | 113 | 116 | 105.8 | 108.7 | 103 | 103.4 | 103 |
| Viscosity, | | | | | | | |
| Krebs | | | | | | | |
| Leneta, Flow | 9 | 9 | 10 | 9 | 9 | 10 | 10 |
| and Leveling | | | | | | | |
| Lenta Anti- | 8 | 12 | 20 | 16 | 16 | 14 | 12 |
| Sag | | | | | | | |
| Resistance | | | | | | | |

### Example 4

### Viscosity Loss in Clear Base Paint

Pigment grind dispersions were made as described in Example 2 but without TiO₂. The dispersions were then combined with additional ingredients to make clear base paint formulations. The resulting base paint formulations were allowed to equilibrate and then tinted with 12 ounces of colorant per gallon of paint using a double strength organic red colorant. Loss in viscosity relative to the formulation without colorant was measured along with Leneta sag resistance and Leneta flow and leveling as described above. Results are shown in Table 3.

TABLE 5
Viscosity loss of clear base paint with
double strength organic red colorant

| | Change in | | Flow and |
|---|---|---|---|
| Example | viscosity (KU) | Sag | Leveling |
| Comparative Example A | −37.8 | 6 | 10 |
| Inventive Example 1 | −14.4 | 24 | 7 |
| Inventive Example 2 | −23.5 | 14 | 10 |
| Inventive Example 3 | −24.5 | 10 | 10 |
| Inventive Example 4 | −26.1 | 10 | 9 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element that is not specifically disclosed herein.

What is claimed is:

1. A coating composition, comprising:
a water-soluble polyurethane rheology modifier formed by condensation of
(a) at least one compound of formula (I):
R—(OE)ₘ—OH (I)
wherein:
R is one or more aromatic moieties having between 2 and 5 phenyl rings;
OE is a polyethoxylated chain; and
m is an number between about 6 and about 12;
(b) at least one poly(alkylene glycol); and
(c) at least one polyisocyanate,
wherein the coating composition has a Leneta sag resistance of greater than about 14 and a Leneta flow and leveling of greater than about 9, and a Stormer viscosity of less than about 120 Krebs units.

2. The coating composition of claim 1, wherein R is one or more aromatic moieties including a tristyryl phenyl group.

3. The coating composition of claim 1, wherein the one or more aromatic moieties include between about 25 and 40 carbon atoms.

4. The coating composition of claim 1, wherein at least one aromatic moiety of the group R has the structure of a compound of formula (III):

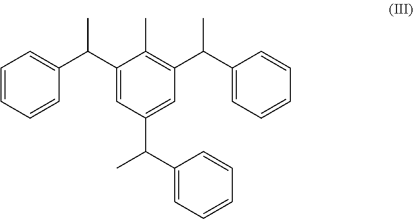 [SMILES: Cc1c(C(C)c2ccccc2)cc(C(C)c2ccccc2)cc1C(C)c1ccccc1]

5. The coating composition of claim 1, wherein m is a number between 8 and 10.

6. The coating composition of claim 1, wherein the composition has a Leneta sag resistance of at least 16 and a Leneta flow and leveling of at least 10.

7. The coating composition of claim 1, wherein the composition has Stormer viscosity of about 90 to 120 KU.

8. A method to improve the sag and leveling of an aqueous coating composition, comprising:
providing an aqueous coating composition; and
adding the water-soluble polyurethane rheology modifier of formula (I) or (II) to the composition to provide a coating composition having a Leneta sag resistance of at least about 14 and a Leneta flow and leveling of at least 9.

9. The method of claim 8, wherein the coating composition is an aqueous TiO₂-containing latex paint system.

10. The composition of claim 1, wherein the poly(alkylene glycol) is poly(ethylene glycol) with molecular weight (Mw) of about 2,000 g/mol to about 20,000 g/mol.

11. A coating composition, comprising:
a water-soluble polyurethane rheology modifier formed by condensation of
(a) at least one compound of formula (II): 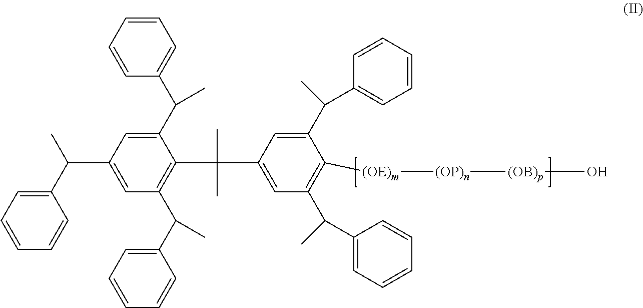
wherein:
[(EO)ₘ—(PO)ₙ—(BO)ₚ] is a polyalkoxylated chain including alkoxylated units chosen from among ethoxylated units EO, propoxylated units PO, and butoxylated units BO,
m, n and p are each independently either zero, or a whole number between 2 and 250, wherein the sum of m, n and p is between 2 and 250;
(b) at least one poly(alkylene glycol); and
(c) at least one polyisocyanate,
wherein the coating composition has a Leneta sag resistance of greater than about 14 and a Leneta flow and leveling of greater than about 9, and a Stormer viscosity of less than about 120 Krebs units.

12. The coating composition of claim 11, wherein the polyalkoxylate is selected from compounds with alkoxylated units in blocked form, alternating form, random form, and mixtures thereof.

13. The coating composition of claim 11, wherein the sum of m, n, and p is a number between 2 and 20.

14. The coating composition of claim 11, wherein the composition has a Leneta sag resistance of at least 16 and a Leneta flow and leveling of at least 9.

15. The coating composition of claim 11, wherein the composition has Stormer viscosity of about 90 to 120 KU.
